(19) United States
(12) Patent Application Publication
(10) Pub. No.: US 2019/0238023 A1
(43) Pub. Date: Aug. 1, 2019

(54) ROTOR OF ROTATING ELECTRICAL MACHINE

(71) Applicant: HONDA MOTOR CO., LTD., Tokyo (JP)

(72) Inventor: Kengo OHIRA, Saitama (JP)

(73) Assignee: HONDA MOTOR CO., LTD., Tokyo (JP)

(21) Appl. No.: 16/255,995

(22) Filed: Jan. 24, 2019

(30) Foreign Application Priority Data
Jan. 30, 2018 (JP) 2018-014092

(51) Int. Cl. H02K 5/15; H02K 1/22; H02K 7/00

(52) U.S. Cl. CPC H02K 5/15; H02K 7/003; H02K 1/22

(57) ABSTRACT

A rotor of a rotating electrical machine includes: a rotor shaft; a rotor yoke press-fitted to an outer circumferential portion of the rotor shaft; and a pair of end plates disposed on both axial sides of the rotor yoke. One end plate of the pair of the end plates is disposed between a plate fixing portion provided in the rotor shaft and one axial end surface of the rotor yoke, the plate fixing portion includes an inclined surface which is inclined such that an outer diameter size gradually increases as it goes away from the one axial end surface of the rotor yoke along a press-fitting direction of the rotor yoke, and an inner circumferential surface of the one end plate includes an inner circumferential inclined surface in contact with the inclined surface of the plate fixing portion.

### CROSS-REFERENCE TO RELATED APPLICATIONS

The present application claims the benefit of priority of Japanese Patent Application No. 2018-014092, filed on Jan. 30, 2018, the content of which is incorporated herein by reference.

### TECHNICAL FIELD

The present invention relates to a rotor of a rotating electrical machine mounted on an electric vehicle or the like.

### BACKGROUND ART

In the related arts, a rotating electrical machine equipped with a stator has been known (for example, JP-A-2017-208883).

As illustrated in FIGS. 5A and 5B, a rotor 100 of a general rotating electrical machine includes a rotor shaft 101 which includes a flange portion 102 on one axial side, a rotor yoke 104 which is formed by stacking plurality of electromagnetic steel plates 103 and press-fitting them to the rotor shaft 101, and an end-face plate 105 which is provided in one axial end portion of the rotor yoke 104 and holds a magnet (not illustrated) accommodated in the rotor yoke 104. The end-face plate 105 may be used as a central axis cooling oil passage in addition to having a magnet popping-out prevention function, and thus it is necessary to prevent relative rotation (phase shift) between the rotor shaft 101 and the end-face plate 105 due to vibration or the like.

The end-face plate 105 is disposed to face one axial end surface 104a of the rotor yoke 104 and is fixed to the rotor shaft 101 by being interposed between the flange portion 102 of the rotor shaft 101 and the rotor yoke 104.

Specifically, when the plurality of stacked electromagnetic steel plates 103 are press-fitted to the rotor shaft 101, the stacked electromagnetic steel plates 103 are contracted and elastic force N is generated. Then, frictional force F (F=μN) by the elastic force N acts between the flange portion 102 and one end surface 105a of the end-face plate 105 and between the other end surface 105b of the end-face plate 105 and the end surface 104a of the rotor yoke 104, and thus the end-face plate 105 is fixed to the rotor shaft 101. Therefore, relative rotation (phase shift) of the end-face plate 105 is prevented.

As described above, since the end-face plate 105 of the related art is fixed to the rotor shaft 101 by the frictional force F by the elastic force N of the rotor yoke 104, force greater than that for press-fitting the rotor yoke 104 to the rotor shaft 101 is necessary during press-fitting of the rotor yoke 104. Therefore, influence on strength of the end-face plate 105 is great.

FIG. 6 is a schematic cross-sectional view of a rotor including an adhesive-type rotor yoke. As illustrated in FIG. 6, in the rotor 100A, the plurality of electromagnetic steel plates 103 are fixed to one another with an adhesive. Therefore, even when the end-face plate 105 is to be interposed between the flange portion 102 and the rotor yoke 104, elastic force by the electromagnetic steel plates 103, that is, force for pressing the end-face plate 105 to the flange portion 102 is small. As a result, there is a possibility that a phase of the end-face plate 105 is shifted relative to the rotor shaft 101

### SUMMARY

The invention provides a rotor of a rotating electrical machine capable of reducing a press-fitting load of the rotor yoke and effectively preventing relative rotation of an end plate relative to a rotor shaft.

According to an aspect of the invention, there is provided a rotor of a rotating electrical machine including: a rotor shaft; a rotor yoke press-fitted to an outer circumferential portion of the rotor shaft; and a pair of end plates disposed on both axial sides of the rotor yoke, wherein: one end plate of the pair of the end plates is disposed between a plate fixing portion provided in the rotor shaft and one axial end surface of the rotor yoke; the plate fixing portion includes an inclined surface which is inclined such that an outer diameter size gradually increases as it goes away from the one axial end surface of the rotor yoke along a press-fitting direction of the rotor yoke; and an inner circumferential surface of the one end plate includes an inner circumferential inclined surface in contact with the inclined surface of the plate fixing portion.

### Effects

According to the invention, the plate fixing portion includes the inclined surface which is inclined such that the outer diameter size is gradually increased as it goes away from the one axial end surface of the rotor yoke along the press-fitting direction of the rotor yoke and the inner circumferential surface of the end plate includes the inner circumferential inclined surface in contact with the inclined surface of the plate fixing portion. Thus, when the rotor yoke is press-fitted, the inner circumferential inclined surface of the end plate is pressed and expanded. In this case, a surface pressure is generated between the inner circumferential inclined surface and the inclined surface by force trying to return the inner circumferential inclined surface to the original state and frictional force F is generated. One axial end surface of the rotor yoke presses the end plate, and thus the frictional force between the inner circumferential inclined surface of the end plate and the inclined surface of the plate fixing portion is maintained. As a result, relative rotation of the end plate can be restricted. A press-fitting load of the rotor yoke can be made smaller than that in a case where an end plate is interposed between a plate fixing portion and one axial end surface of the rotor yoke.

### BRIEF DESCRIPTION OF THE DRAWINGS

FIG. 1 is a perspective view of a rotor of a rotating electrical machine according to an embodiment of the invention;

FIG. 2 is a cross-sectional view taken along the line A-A of FIG. 1;

FIG. 3 is an enlarged view of a portion B in FIG. 2;

FIG. 4A is a schematic cross-sectional view of a main part of the rotor before a rotor yoke and an end plate are assembled to a rotor shaft;

FIG. 4B is a schematic cross-sectional view of the main part of the rotor after the rotor yoke and the end plate are assembled to the rotor shaft;

FIG. 5A is a schematic cross-sectional view of a rotor of the related art which illustrates a state before a rotor yoke and an end plate are assembled;

FIG. 5B is a schematic cross-sectional view of the rotor of the related art which illustrates a state after the rotor yoke and the end plate are assembled; and

FIG. 6 is a schematic cross-sectional view of a rotor of the related art which includes an adhesive type rotor core.

### DETAILED DESCRIPTION OF EMBODIMENT

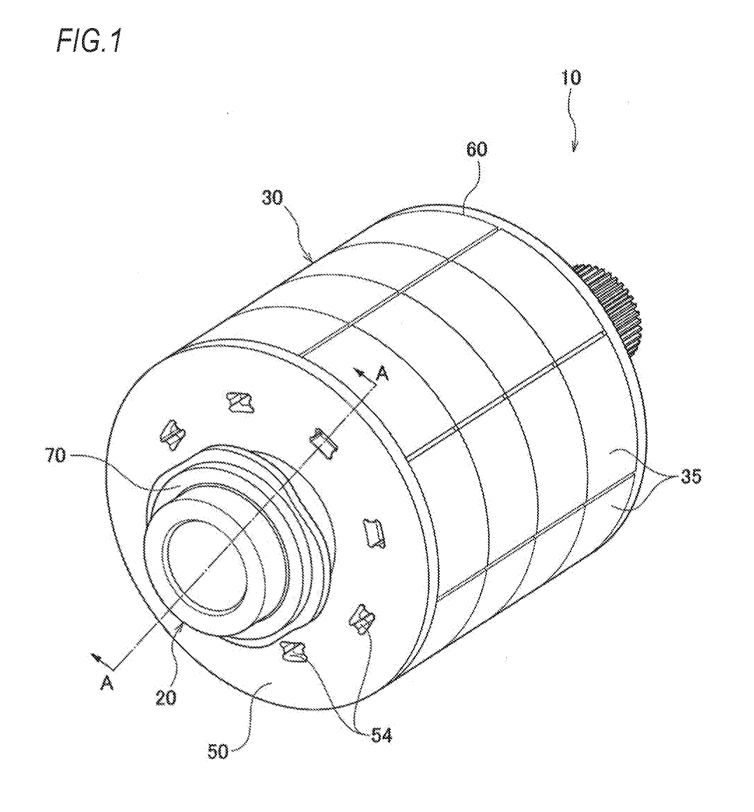

Hereinafter, a rotor of a rotating electrical machine according to an embodiment of the invention will be described with reference to FIGS. 1 to 4B.

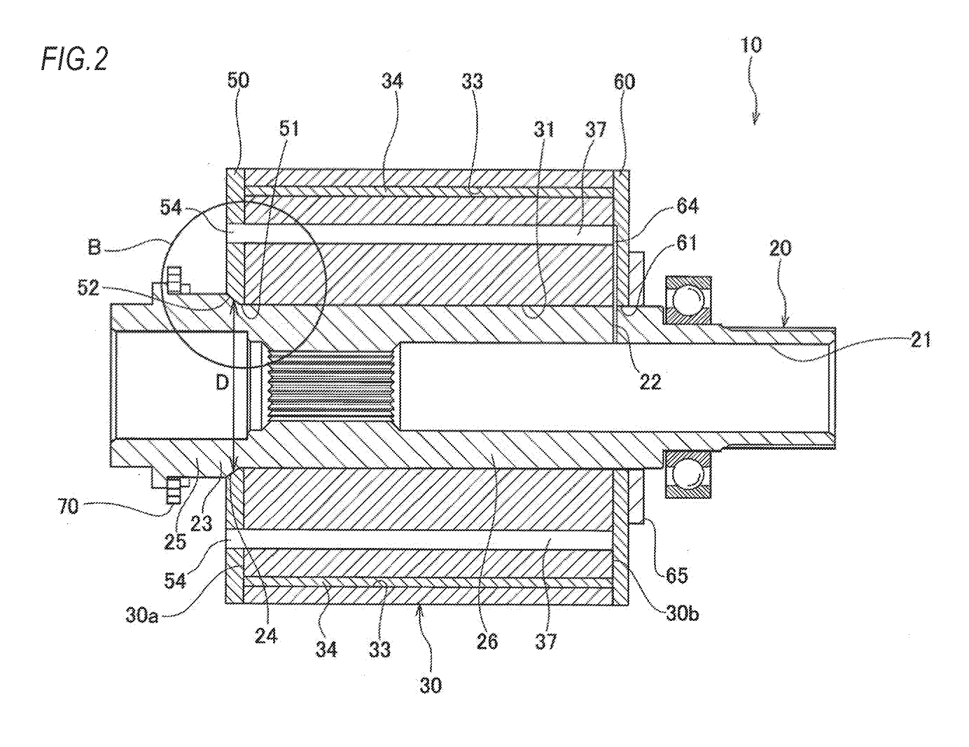

As illustrated in FIGS. 1 and 2, a rotor 10 of a rotating electrical machine according to the embodiment includes a rotor shaft 20, a rotor yoke 30 press-fitted to an outer circumferential portion of the rotor shaft 20, a first end plate 50 disposed on one axial side of the rotor yoke 30, a second end plate 60 disposed on the other axial side of the rotor yoke 30, and a resolver 70 for detecting a rotation angle of the rotor 10.

In the rotor shaft 20, a cooling passage 21 through which a coolant flows is formed inside the rotor shaft 20. The cooling passage 21 extends in an axial direction inside the rotor shaft 20 and is configured so that the coolant can be supplied from the outside. As the coolant, for example, automatic transmission fluid (ATF) is used and a supply path is formed so that the ATF circulates between a transmission case and a motor housing.

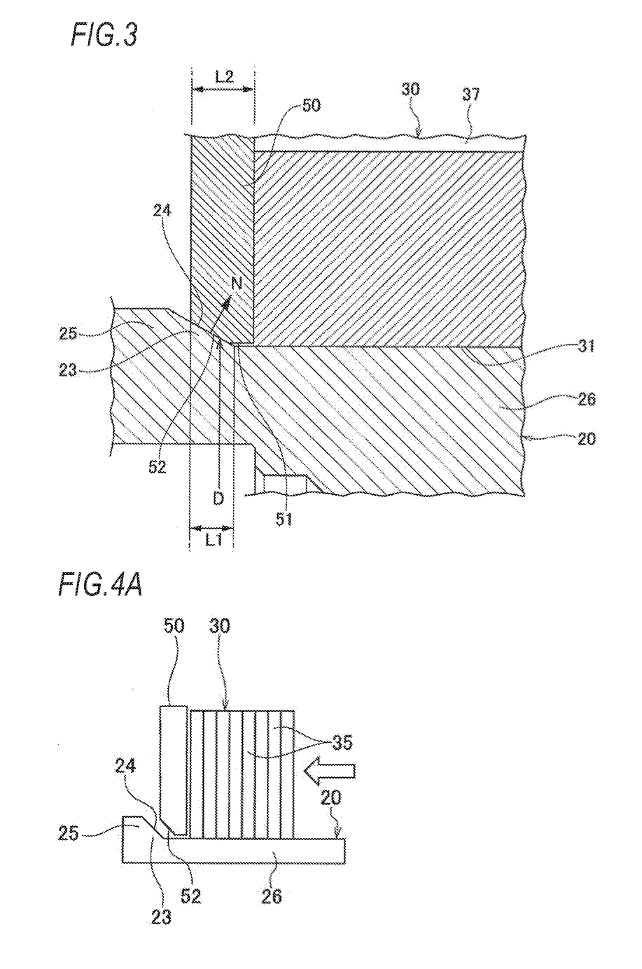

In the rotor shaft 20, a coolant supply hole portion 22 for feeding the coolant from the cooling passage 21 to a portion between the rotor yoke 30 and the second end plate 60 is formed. A large diameter portion 25 including a plate fixing portion 23 is formed at one end (left-side end portion in FIG. 2) of the rotor shaft 20. An outer circumferential surface of the plate fixing portion 23 includes an inclined surface 24 connecting an outer circumferential surface of a small diameter portion 26 of the rotor shaft 20 to which the rotor yoke 30 is press-fitted and an outer circumferential surface of the large diameter portion 25. In FIGS. 2 and 3, the inclined surface 24 is formed to be inclined such that an outer diameter size D gradually increases as it extends from a right side to a left side in a press-fitting direction of the rotor yoke 30.

In the large diameter portion 25, the resolver 70 is fixed further on a left side than the inclined surface 24 in a press-fitting manner.

The rotor yoke 30 is formed by stacking electromagnetic steel plates 35 having substantially the same shape along a left-right direction in FIG. 2 and connecting them through caulking, bonding, or welding. The rotor yoke 30 has a cylindrical shape and a rotor insertion hole 31 passing through the rotor yoke 30 in an axial direction is formed in a central portion thereof. Frictional force is generated between an inner circumferential surface of the rotor insertion hole 31 and an outer circumferential surface of the rotor shaft 20 by press-fitting the rotor yoke 30 to the rotor shaft 20, so that the rotor yoke 30 is fixed to the rotor shaft 20.

A coolant passage 37 is formed in the rotor yoke 30 to pass through the rotor yoke 30 in the axial direction. On an outer circumferential side of the rotor yoke 30, magnets 34 are embedded in hollow portions 33 formed at predetermined intervals along a circumferential direction. The magnet 34 is, for example, a permanent magnet such as a neodymium magnet and constitutes magnetic pole sections of the rotor 10.

As illustrated in FIG. 3, the first end plate 50 is a disk-shaped member formed of aluminum, stainless steel, or the like and a shaft insertion hole 51 is formed in a central portion thereof. An inner circumferential inclined surface 52 having substantially the same inclination angle as the inclined surface 24 of the plate fixing portion 23 is formed on an inner circumferential surface of the shaft insertion hole 51.

An axial width L1 of the inner circumferential inclined surface 52 is equal to or greater than 10% of an axial width L2. of the inner circumferential surface of the first end plate 50. The axial width L1 of the inner circumferential inclined surface 52 is 100% or less, preferably 90% or less of the axial width L2 of the inner circumferential surface of the first end plate 50.

It is preferable that the angle of the inclined surface 24 of the plate fixing portion 23 and the inner circumferential inclined surface 52 of the first end plate 50 be set to 5° to 60° relative to the rotor insertion hole 31 in a cross-sectional view of FIG. 3. As a result, a contact area between the inclined surface 24 and the inner circumferential inclined surface 52 is increased and a surface pressure is increased, so that the first end plate 50 can be firmly fixed to the rotor shaft 20.

Although it will be described in detail below, the first end plate 50 is fixed to the rotor shaft 20 by press-fitting the inclined surface 24 of the rotor shaft 20 to the inner circumferential inclined surface 52 of the shaft insertion hole 51.

Returning to FIGS. 1 and 2, on the first end plate 50 abutting on an end surface 30a on one axial side of the rotor yoke 30, a plurality of coolant discharge holes 54 for discharging the coolant to outside are formed at the same diameter position as the coolant passages 37 to pass through the first end plate 50 in the axial direction. For the coolant discharge hole 54 to discharge the coolant flowing through the coolant passage 37 to the outside, it is necessary for the coolant discharge hole 54 to communicate with the coolant passage 37. Therefore, the first end plate 50 needs to be fixed to not rotate relative to a rotor shaft 20 to which the rotor yoke 30 is press-fitted.

The second end plate 60 is a disk-shaped member formed of aluminum, stainless steel, or the like and a shaft insertion hole 61 is formed in a central portion thereof, and the rotor shaft 20 is loosely fitted to the shaft insertion hole 61. The second end plate 60 abuts on an end surface 30b on the other axial side of the rotor yoke 30 and is positioned at an axial position by an end plate collar 65 press-fitted to the rotor shaft 20.

In the second end plate 60, an annular groove 64 which communicates with the coolant supply hole portion 22 of the rotor shaft 20 and communicates with the coolant passage 37 is formed on an inner side surface on a rotor yoke 30 side.

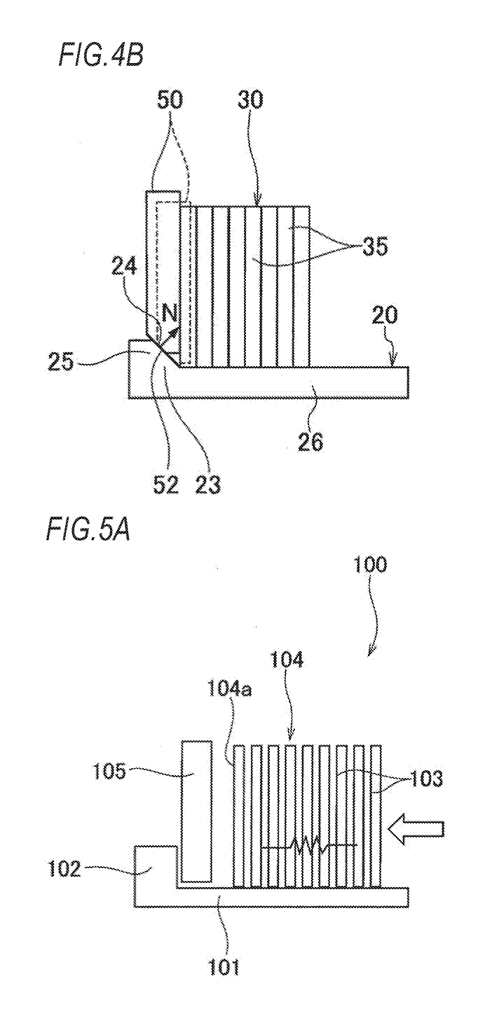

Next, a process of assembling the first end plate 50 to the rotor shaft 20 will be described with reference to FIGS. 4A and 4B. As illustrated in FIG. 4A, the first end plate 50 and the rotor yoke 30 are inserted into the rotor shaft 20 from an end portion on a side opposite to the large diameter portion 25. The first end plate 50 is inserted while a large diameter side of the shaft insertion hole 51 (inner circumferential inclined surface 52) is directed toward the large diameter portion 25.

Then, when the rotor yoke 30 is pressed against the large diameter portion 25, as illustrated in FIG. 4B, the stacked electromagnetic steel plates 35 are compressed and elastic force generated in the rotor yoke 30 causes the first end plate 50 to move in a left direction from a position indicated by a broken line in the drawing to a position indicated by a solid line. Therefore, the inclined surface 24 of the rotor shaft 20 is press-fitted to the inner circumferential inclined surface 52 of the first end plate 50.

When the inclined surface 24 is press-fitted to the inner circumferential inclined surface 52, an inner diameter of the inner circumferential inclined surface 52 of the first end plate 50 is pressed and expanded by the inclined surface 24. Then, a surface pressure is generated between the inner circumferential inclined surface 52 and the inclined surface 24 by force trying to return the inner diameter of the inner circumferential inclined surface 52 to the original state and frictional force F (F=μN) is generated, and thus the first end plate 50 is fixed to the rotor shaft 20.

Since the first end plate 50 is kept pressed toward the large diameter portion 25 by the end surface 30a of the rotor yoke 30, the surface pressure between the inner circumferential inclined surface 52 of the first end plate 50 and the inclined surface 24 of the rotor shaft 20 is maintained for a long period of time.

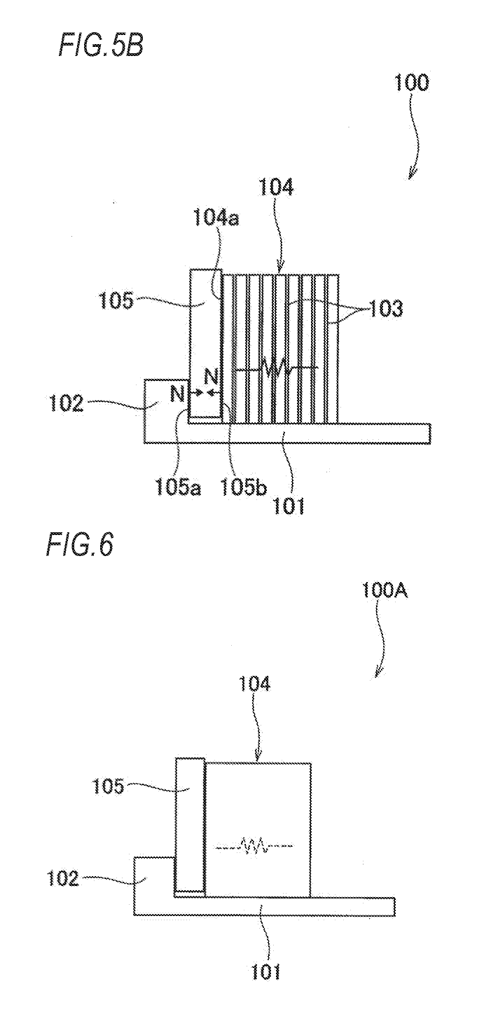

Pressing force for pressing the rotor yoke 30 during press-fitting of the rotor yoke 30 can be made smaller than that in a case (see FIGS. 5A and 5B) where an end-face plate 105 is interposed between a flange portion 102 and a side surface of a rotor yoke 104. That is, in a rotor 100 of the related art, pressing force during press-fitting of the rotor yoke 104 requires a load for always pressing the end-face plate 105 in addition to a load for press-fitting the end-face plate 105 and the rotor yoke 104 to predetermined positions. However, in the rotor 10 of the embodiment, pressing force may only require a load (small load) for pressing the inner circumferential inclined surface 52 of the first end plate 50 in addition to a load for press-fitting the first end plate 50 and the rotor yoke 30 to predetermined positions.

In a case of a so-called adhesive-type rotor yoke 30 in which a plurality of electromagnetic steel plates 35 are fixed with an adhesive, elastic force due to shrinkage of the electromagnetic steel plates cannot be expected. However, the first end plate 50 is fixed to the rotor shaft 20 by elastic deformation of the inner circumferential inclined surface 52 of the first end plate 50, and thus the first end plate 50 can be reliably fixed to the rotor shaft 20 even in a case of the adhesive-type rotor yoke 30.

The embodiment described above can be appropriately modified, improved, or the like. For example, in the embodiment described above, there is no mention about the surface conditions of the inner circumferential inclined surface 52 of the first end plate 50 and the inclined surface 24 of the rotor shaft 20. However, frictional coefficient between the inner circumferential inclined surface 52 and the inclined surface 24 may be increased by forming frictional force increasing portions such as knurls, streaks, and grooves on either or both of the inner circumferential inclined surface 52 of the first end plate 50 and the inclined surface 24 of the rotor shaft 20. As a result, the first end plate 50 is further firmly fixed to the rotor shaft 20.

At least the following matters are described in this specification. Although the corresponding constituent elements and the likes in the embodiment described above are described in parentheses, it is not limited thereto.

(1) A rotor (rotor 10) of a rotating electrical machine which includes:

a rotor shaft (rotor shaft 20),

a rotor yoke (rotor yoke 30) press-fitted to an outer circumferential portion of the rotor shaft, and

a pair of end plates (first and second end plates 50 and 60) disposed on both axial sides of the rotor yoke, in which

one end plate (first end plate 50) of the pair of the end plates is disposed between a plate fixing portion (plate fixing portion 23) provided in the rotor shaft and one axial end surface (end surface 30a on one axial side) of the rotor yoke,

the plate fixing portion includes an inclined surface (inclined surface 24) which is inclined such that an outer diameter size (outer diameter size D) gradually increases as it goes away from the one axial end surface of the rotor yoke along a press-fitting direction of the rotor yoke, and

an inner circumferential surface (inner circumferential surface of the shaft insertion hole 51) of the one end plate includes an inner circumferential inclined surface (inner circumferential inclined surface 52) in contact with the inclined surface of the plate fixing portion.

According to (1), the plate fixing portion includes the inclined surface which is inclined such that the outer diameter size gradually increases as it goes away from the one axial end surface of the rotor yoke along the press-fitting direction of the rotor yoke and the inner circumferential surface of the one end plate has the inner circumferential inclined surface in contact with the inclined surface of the plate fixing portion. Thus, when the rotor yoke is press-fitted, the inner circumferential inclined surface of the one end plate is pressed and expanded. In this case, a surface pressure is generated between the inner circumferential inclined surface and the inclined surface by force trying to return the inner circumferential inclined surface to the original state and frictional force is generated. One axial end surface of the rotor yoke presses the one end plate, and thus the frictional force between the inner circumferential inclined surface of the one end plate and the inclined surface of the plate fixing portion is maintained. As a result, relative rotation of the one end plate can be restricted. A press-fitting load of the rotor yoke can be made smaller than that in a case where an end plate is interposed between the plate fixing portion and one axial end surface of the rotor yoke,

(2) The rotor of a rotating electrical machine according to (1), in which an axial width (axial width L1) of the inner circumferential inclined surface is set to be equal to or greater than 10% of an axial width (axial width L2) of the inner circumferential surface of the one end plate.

According to (2), the axial width of the inner circumferential inclined surface is set to be equal to or greater than 10% of the axial width of the inner circumferential surface of the one end plate, and thus relative rotation of the one end plate can be restricted further reliably.

(3) The rotor of a rotating electrical machine according to (1) or (2), in which the rotor yoke is formed by stacking a plurality of electromagnetic steel plates (electromagnetic steel plates 35) via an adhesive.

According to (3), relative rotation of the one end plate is restricted by the frictional force between the inner circumferential inclined surface of the one end plate and the inclined surface of the plate fixing portion. Therefore, even in a case of a so-called adhesive yoke in which a plurality of electromagnetic steel plates are stacked via an adhesive, relative rotation of the one end plate can be appropriately restricted.

(4) The rotor of a rotating electrical machine according to any one of (1) to (3), in which

at least one of the inner circumferential inclined surface of the one end plate and the inclined surface of the plate fixing portion includes a frictional force increasing portion (knurl, streak, or groove).

According to (4), since at least one of the inner circumferential inclined surface of the one end plate and the inclined surface of the plate fixing portion includes the frictional force increasing portion, it is possible to increase frictional force for restricting relative rotation of the one end plate. Therefore, the relative rotation of the one end plate can be restricted further reliably.

1. A rotor of a rotating electrical machine comprising:
a rotor shaft;
a rotor yoke press-fitted to an outer circumferential portion of the rotor shaft; and
a pair of end plates disposed on both axial sides of the rotor yoke, wherein:
one end plate of the pair of the end plates is disposed between a plate fixing portion provided in the rotor shaft and one axial end surface of the rotor yoke;
the plate fixing portion includes an inclined surface which is inclined such that an outer diameter size gradually increases as it goes away from the one axial end surface of the rotor yoke along a press-fitting direction of the rotor yoke; and
an inner circumferential surface of the one end plate includes an inner circumferential inclined surface in contact with the inclined surface of the plate fixing portion.

2. The rotor of a rotating electrical machine according to claim 1, wherein
an axial width of the inner circumferential inclined surface is set to be equal to or greater than 10% of an axial width of the inner circumferential surface of the one end plate.

3. The rotor of a rotating electrical machine according to claim 1, wherein
the rotor yoke is formed by stacking a plurality of electromagnetic steel plates via an adhesive.

4. The rotor of a rotating electrical machine according to claim 1, wherein
at least one of the inner circumferential inclined surface of the one end plate and the inclined surface of the plate fixing portion has a frictional force increasing portion.
